(19) United States
(12) Patent Application Publication
(10) Pub. No.: US 2018/0160326 A1
(43) Pub. Date: Jun. 7, 2018

(54) COMMUNICATION CONTROLLING METHOD, COMMUNICATION CONTROLLING SYSTEM, BASE STATION AND SERVER

(71) Applicant: INDUSTRIAL TECHNOLOGY RESEARCH INSTITUTE, Chutung (TW)

(72) Inventor: Chia-Hua LIN, Xinpu Township (TW)

(73) Assignee: INDUSTRIAL TECHNOLOGY RESEARCH INSTITUTE, Chutung (TW)

(21) Appl. No.: 15/382,864

(22) Filed: Dec. 19, 2016

(30) Foreign Application Priority Data
Dec. 1, 2016 (TW) 105139705

(51) Int. Cl. H04W 24/10; H04L 5/00; H04L 27/26; H04L 25/02; G06F 17/30

(52) U.S. Cl. CPC H04W 24/10; H04L 5/0048; H04W 88/08; H04L 25/0226; G06F 17/30501; H04L 27/265

(57) ABSTRACT

A communication controlling method, a communication controlling system, a base station and a server are provided. A communication controlling method includes obtaining frequency-domain channel information by a first communication device, transforming the frequency-domain channel information into a compressed data according to a sensing matrix by the first communication device, transmitting the compressed data to a second communication device by the first communication device, restoring the compressed data to time-domain channel information by the second communication device, and transforming the time-domain channel information into the frequency-domain channel information by the second communication device.

This application claims the benefit of Taiwan application Serial No. 105139705, filed Dec. 1, 2016, the disclosure of which is incorporated by reference herein in its entirety.

### TECHNICAL FIELD

The disclosure relates to a communication controlling method, a communication controlling system, a base station and a server.

### BACKGROUND

Demands on both wired and wireless network communications have grown exponentially in the recent years. Providing users with better communication quality and communication speed is an essential task needing to be tackled and resolved. Various research organizations are currently focusing on and preparing development of next generation communication technologies. To enhance communication performance, technologies that can be looked into include increasing bandwidth, improving spectrum utilization efficiency and increasing the density of base stations.

Increasing the density of base stations implies that, severe signal interference is caused when the same frequency band is used in the same period. Therefore, there is a need for a solution for the above issue.

### SUMMARY

The disclosure is directed to a communication controlling method, a communication controlling system, a base station and a server.

According to an embodiment of the disclosure, a communication controlling method is provided. The communication controlling method includes obtaining a frequency-domain channel information by a first communication device, transforming the frequency-domain channel information into a compressed data according to a sensing matrix by the first communication device, transmitting the compressed data to a second communication device by the first communication device, restoring the compressed data to a time-domain channel information by the second communication device, and transforming the time-domain channel information into the frequency-domain channel information by the second communication device.

According to another embodiment of the disclosure, a communication controlling system is provided. The communication controlling system includes a first communication device and a second communication device. The first communication device is configured to obtain a frequency-domain information, transform the frequency-domain channel information into a compressed data and transmit the compressed data. The second communication device is configured to receive the compressed data, restore the compressed data to a time-domain channel information and transform the time-domain channel information into the frequency-domain channel information.

According to an embodiment of the disclosure, a base station is provided. The base station includes a reference signal receiving unit and a compressing unit. The reference signal receiving unit is configured to receive a reference signal to obtain a frequency-domain channel information. The compressing unit transforms the frequency-domain information into a compressed data according to a sensing matrix. The compressed data is transmitted to a server.

According to yet another embodiment of the disclosure, a server is provided. The server includes a compressed data receiving unit, a restoring unit and a transforming unit. The compressed data receiving unit is configured to obtain a compressed data. The restoring unit is configured to restore the compressed data to a time-domain channel information. The transforming unit is configured to transform the time-domain channel information into the frequency-domain channel information.

### BRIEF DESCRIPTION OF THE DRAWINGS

FIG. 1 is a schematic diagram of a communication controlling system according to an embodiment;

FIG. 2 is a block diagram of a communication controlling system according to an embodiment;

FIG. 3 is a flowchart of a communication controlling method according to an embodiment;

FIG. 4 is a schematic diagram of a communication controlling system according to another embodiment;

FIG. 5 is a flowchart of a communication controlling method according to another embodiment;

FIG. 6 is a block diagram of a reference signal receiving unit according to an embodiment;

FIG. 7 is a block diagram of a compressing unit according to an embodiment; and

FIG. 8 is a block diagram of an adjusting unit according to an embodiment.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

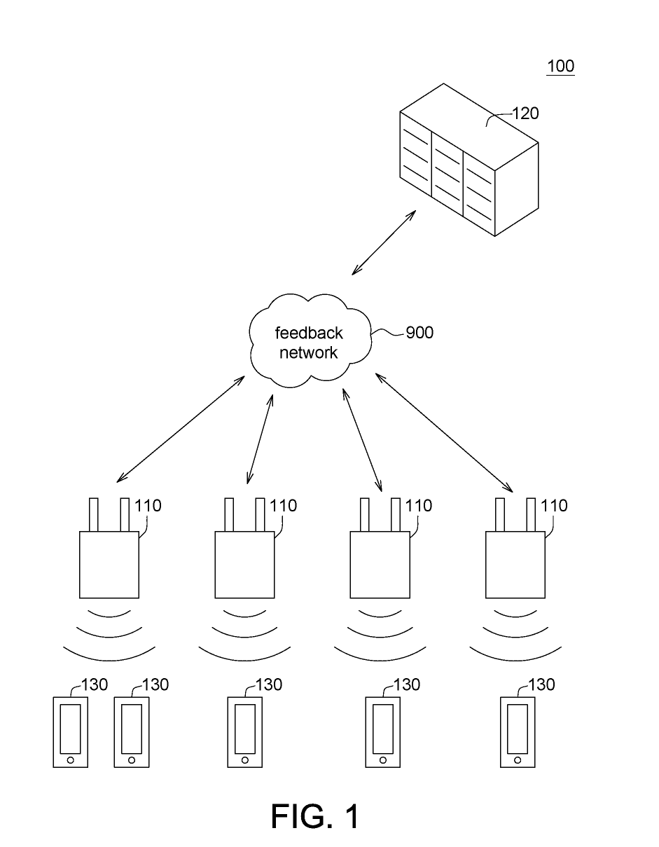

FIG. 1 shows a schematic diagram of a communication controlling system 100 according to an embodiment. The communication controlling system 100 includes at least one base station 110, a server 120 and at least one user equipment 130. The base station 110 may be a large or small base station with fundamental base station functions, for example but not limited to, a base station of any type or a Femtocell. For example, the server 120 is formed by multiple computers. The user equipment 130 may be any user equipment that communicates with a base station, for example but not limited to, a desktop computer, a cell phone, a smart wearable device (e.g., a smart watch or a smart wristband), a tablet computer, or a laptop computer. To accommodate the rapid growth of communication network data, the communication controlling system 100 is allotted with a large amount of base stations 110 to adequately handle immense amounts of transmission data, hence constructing an Ultra Dense Network (UDN). Due to the allotment of the high-density network, severe interference is resulted when the same frequency band is used within the same time period. To overcome such issue, a Coordinated Multipoint Processing (CoMP) mechanism may be adopted to achieve the object of interference elimination. However, the CoMP mechanism is required to return huge amounts of channel information for the server 120 at a backend for computations in order to eliminate interference among the base stations 110, wherein the channel information refers to channel coefficients between the base stations 110 and the user equipments 130. Because the channel information occupies a large part of the bandwidth, the above approach is considered an uneconomical behavior. In the embodiments of the disclosure, a compressive sensing (CS) technology is adopted by using sparsity of channel information to reduce the bandwidth occupied by channel information.

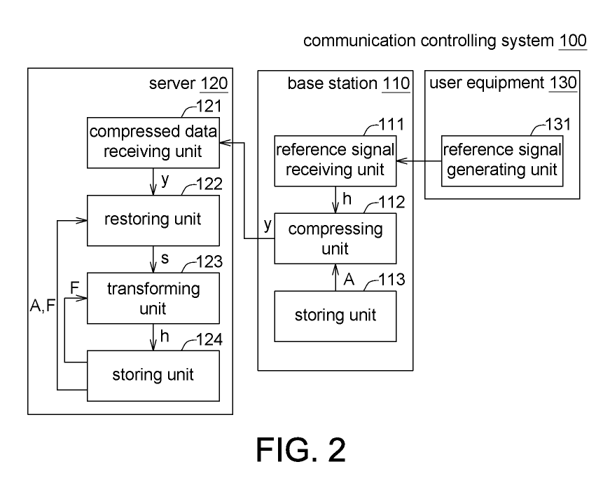

FIG. 2 shows a block diagram of the communication controlling system 100 according to an embodiment. The base station 110 is configured to include a reference signal receiving unit 111, a compressing unit 112 and a storage unit 113. The reference signal receiving unit 111 is, for example but not limited to, an antenna, a radio-frequency (RF) chip, a circuit board, an amplifying circuit that is configured to receive signals or the combination thereof. The compressing unit 112 is, for example but not limited to, a circuit, a chip, a circuit board, or a recording device storing multiple sets of program codes that is configured to perform various processes and operations. The storage unit 113 is, for example but not limited to, a memory, a hard drive, a portable disk or a cloud storage center that is configured to store data.

The server 120 is configured to include a compressed data receiving unit 121, a restoring unit 122, a transforming unit 123 and a storage unit 124. The compressed data receiving unit 121 is, for example but not limited to, at least one of an antenna, an RF chip, a circuit board, an amplifying circuit or the combination thereof that is configured to receive signals. Each of the restoring unit 122 and the transforming unit 123 is, for example but not limited to, a circuit, a chip, a circuit board or a recording device storing multiple sets of program codes that is configured to perform various processes and operations. The storage unit 124 is, for example but not limited to, a memory, a hard drive, a portable disk or a cloud storage center that is configured to store data.

The user equipment 130 is configured to include a reference signal generating unit 131. The reference signal generating unit 131 is, for example but not limited to, a circuit, a chip, a circuit board or a recording device storing multiple sets of program codes that is configured to generate various kinds of signals.

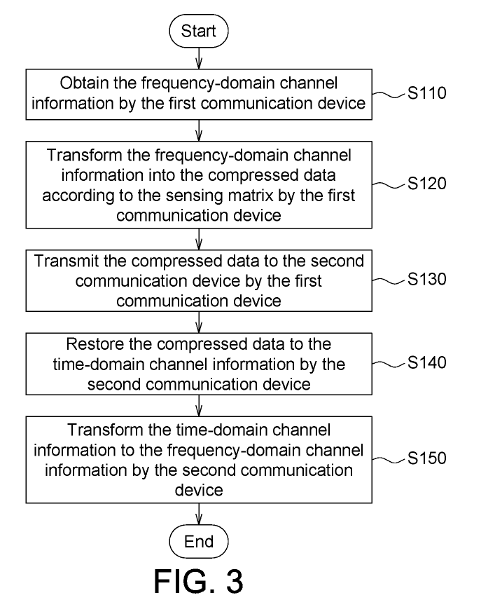

Operations of the above components are given in detailed with reference to a flowchart according to an embodiment below. FIG. 3 shows a flowchart of a communication controlling method according to an embodiment. A first communication device may be the base station 110, the server 120 or the user equipment 130. A second communication device may be the base station 110, the server 120 or the user equipment 130. A third communication device may be the base station 110, the server 120 or the user equipment 130. In the description below, the first communication device is the base station 110 as an example for illustrations, the second communication device is the server 120 as an example for illustration, and the third communication device is the user equipment 130 as an example for illustrations. Details of the steps of the flowchart are given further with reference to the components in FIG. 2.

In step S110, the reference signal receiving unit 111 of the base station 110 is configured to obtain frequency-domain channel information h. For example, the frequency-domain channel information h is a matrix of equation (1) below:

$$h = [ \begin{matrix}1 \\ - i \\ - 1 \\ i \\ 1 \\ - i \\ - 1 \\ i\end{matrix} ] \qquad ( 1 )$$

For example, the frequency-domain channel information h is obtained by measuring the channel from the user equipment 130 to the base station 110. After a reference signal generated by the user equipment 130 passes changes of the channel and is received by the reference signal receiving unit 111 of the base station 110, information of the channel is estimated by channel estimation to provide the frequency-domain channel information h.

In step S120, the compressing unit 112 of the base station 110 is configured to transform the frequency-domain channel information h into a compressed data y according to a sensing matrix A. In an embodiment, according to a parameter of a compression ratio, the estimated frequency-domain channel information h may be randomly linearly combined, and the sensing matrix A is a random linear combiner matrix. For example, the sensing matrix A may be stored in the storage unit 113 in advance, and may be, for example, a matrix in equation (2) below:

$$A = [ \begin{matrix}1 & 1 & 1 & 0 & 0 & 0 & 0 & 0 \\ 1 & 1 & 0 & 1 & 1 & 0 & 0 & 0 \\ 1 & 0 & 0 & 1 & 0 & 1 & 1 & 1\end{matrix} ] \qquad ( 2 )$$

The frequency-domain channel information h is transformed into the compressed data y according to equation (3) below. That is to say, the compressed data y is a linear combination of a part of data of the frequency-domain channel information h.

$$y = A h = [ \begin{matrix}1 & 1 & 1 & 0 & 0 & 0 & 0 & 0 \\ 1 & 1 & 0 & 1 & 1 & 0 & 0 & 0 \\ 1 & 0 & 0 & 1 & 0 & 1 & 1 & 1\end{matrix} ] [ \begin{matrix}1 \\ - i \\ - 1 \\ i \\ 1 \\ - i \\ - 1 \\ i\end{matrix} ] = [ \begin{matrix}- i \\ 2 \\ i\end{matrix} ] \qquad ( 3 )$$

As such, the frequency-domain channel information h having a length of 8 is compressed to the compressed data y having a length of 3.

In step S130, the compressing unit 112 of the base station 110 is configured to transmit the compressed data y to the compressed data receiving unit 121 of the server 120 through a feedback network 900 (in FIG. 1).

In step S140, the restoring unit 122 of the server 120 is configured to restore the compressed data y to a time-domain channel information s. In this step, the restoring unit 122 is configured to obtain the time-domain channel information s according to equation (4) below. The sensing matrix A and a fast Fourier transform (FFT) matrix F may be stored in the storage unit 124 in advance. The obtained time-domain channel information s is represented in equation (5) below:

$$\begin{matrix}y = AFs = [ \begin{matrix}3 & 1 - i + ω & - i & 1 + i ( 1 - ω ) & 1 & 1 - i - ω & i & 1 + i ( 1 + ω ) \\ 4 & ( 1 - i ) ω & 2 & ( 1 - i ) ω & 0 & ( 1 - i ) ω & 2 & ( 1 - i ) ω \\ 5 & 1 + i - ω & 1 & 1 + i ( 1 - ω ) & - 1 & 1 + i + ω & - i & 1 - i ( 1 + ω )\end{matrix} ] s & ( 4 ) \\ S = [ \begin{matrix}0 \\ 0 \\ 1 \\ 0 \\ 0 \\ 0 \\ 0 \\ 0\end{matrix} ] & ( 5 )\end{matrix}$$

In step S150, the transforming unit 123 of the server 120 is configured to transform the time-domain channel information s into the frequency-domain channel information h through an FFT algorithm. In this step, the transforming unit 123 is configured to obtain the frequency-domain channel information h using the FFT matrix F stored in the storage unit 124 in advance according to equation (6) below:

$$h = Fs = [ \begin{matrix}1 & 1 & 1 & 1 & 1 & 1 & 1 & 1 \\ 1 & ω & - i & - i ω & - 1 & - ω & i & i ω \\ 1 & - i & - 1 & i & 1 & - i & - 1 & i \\ 1 & - i ω & i & ω & - 1 & i ω & - i & - ω \\ 1 & - 1 & 1 & - 1 & 1 & - 1 & 1 & - 1 \\ 1 & - ω & - i & i ω & - 1 & ω & i & - i ω \\ 1 & i & - 1 & - i & 1 & 1 & - 1 & - i \\ 1 & i ω & i & - ω & - 1 & - i ω & - i & ω\end{matrix} ] [ \begin{matrix}0 \\ 0 \\ 1 \\ 0 \\ 0 \\ 0 \\ 0 \\ 0\end{matrix} ] = [ \begin{matrix}1 \\ - i \\ - 1 \\ i \\ 1 \\ - i \\ - 1 \\ i\end{matrix} ] \qquad ( 6 )$$

As such, the base station 110 is required to transmit the compressed data y only having a length of 3, and the frequency-domain channel information h having a length of 8 can then be restored at the server 120, which is equivalently lowering the data size by 62.5% and thus reducing the amount of bandwidth occupied.

In another embodiment, the sensing matrix A may be stored in the base station 110 and the server 120 in advance instead of being transmitted, and so no transmission bandwidth is occupied.

Further, the compressive sensing technology adopted is low-loss compression or lossless compression, in a way that the frequency-domain channel information h may be truly restored.

Further, the user equipment 130 need not perform any FFT operation, so as to prevent additional power consumption of the user equipment 130.

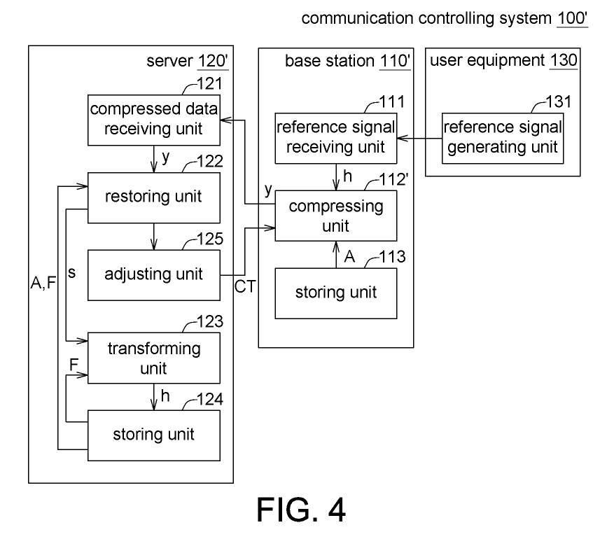

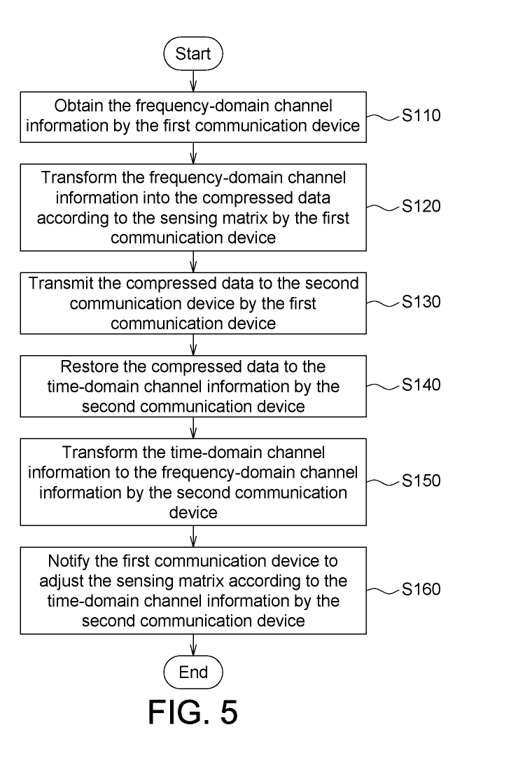

In another embodiment, the sensing matrix A may be adjusted according to a sparsity to better lower the data size. FIG. 4 shows a schematic diagram of a communication controlling system 100′ according to another embodiment. FIG. 5 shows a flowchart of a communication controlling method according to another embodiment. Referring to FIG. 4 and FIG. 5, in the communication controlling system 100′, a server 120′ may be configured to further include an adjusting unit 125, and a compressing unit 112′ of a base station 110′ may be configured to further have a function of adjusting the sensing matrix A.

In an embodiment, in step S160, according to the sparsity of the time-domain channel information s, the adjusting unit 125 of the server 120′ is configured to notify the compressing unit 112′ of the base station 110′ to adjust the sensing matrix A by a notification message CT. In an embodiment, a plurality of candidate matrices may be stored in the storage unit 113 of the base station 110′ in advance, and the sensing matrix A is one selected from these candidate matrices. That is to say, after the sensing matrix A is adjusted, through communication and coordination of the adjusting unit 125, contents of the sensing matrix A adopted by the server 120′ and the base station 110′ are still identical, such that the server 120′ may restore the original frequency-domain channel information h.

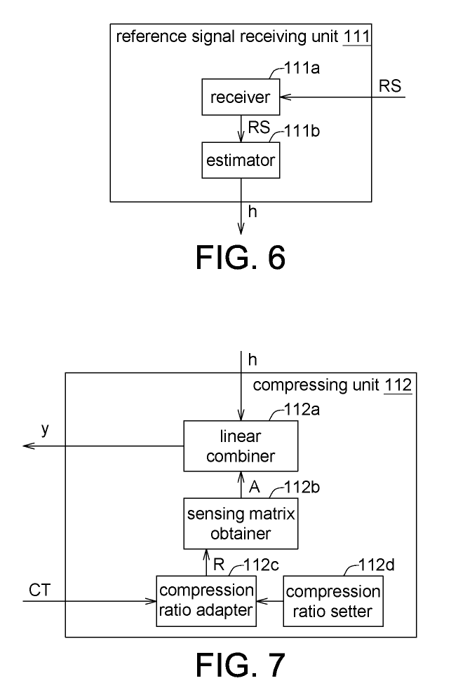

FIG. 6 shows a block diagram of the reference signal receiving unit 111 according to an embodiment. In an embodiment, the reference signal receiving unit 111 is configured to include a receiver 111a and an estimator 111b. The receiver 111a receives a reference signal RS sent from the reference signal generating unit 131. The reference signal RS is transmitted via an uplink channel. The frequency-domain channel information h to be obtained is a channel information of a downlink channel. The estimator 111b may estimate the channel information of the downlink channel according to the contents of the reference signal RS to provide the frequency-domain channel information h.

FIG. 7 shows a block diagram of the compressing unit 112 according to an embodiment. In an embodiment, the compressing unit 112 is configured to include a linear combiner 112a, a sensing matrix obtainer 112b, a compression ratio adapter 112c and a compression ratio setter 112d. After obtaining the frequency-domain channel information h, the linear combiner 112a performs a linear combination according to the sensing matrix A to obtain the compressed data y. The compression ratio adapter 112c provides an appropriate compression ratio R according to a setting value of the compression ratio setter 112d or the notification message CT from the server 120′. The sensing matrix obtainer 112b provides the sensing matrix A according to the compression ratio R.

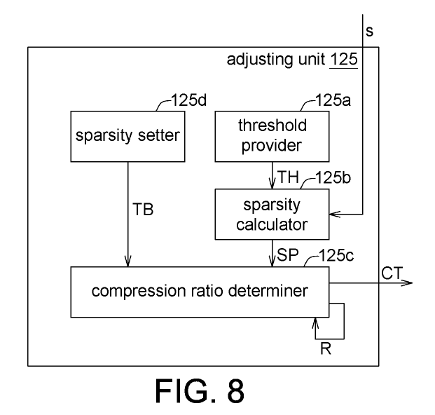

FIG. 8 shows a block diagram of the adjusting unit 125 according to an embodiment. In an embodiment, the adjusting unit 125 is configured to include a threshold provider 125a, a sparsity calculator 125b, a compression ratio determiner 125c and a sparsity setter 125d. After obtaining the time-domain channel information s, the sparsity calculator 125b calculates a sparsity SP according to a threshold TH provided by the threshold provider 125a. After the receiving the sparsity SP, the compression ratio determiner 125c obtains the compression ratio R according to a mapping table TB provided by the sparsity setter 125d, and outputs the notification message CT to the base station 110′.

According to the above embodiments, adopting the compressive sensing technology provides a more apparent compression ratio and reduces the amount of bandwidth occupied. Further, the sensing matrix A adopted need not be transmitted in a way that no transmission bandwidth is occupied. Further, the frequency-domain channel information h is more truly restored, while no excessive power consumption of the user equipment 130 is additionally produced during the operation process. Further, the sensing matrix A is adjustable according to the sparsity to obtain a better compression effect.

It is intended that the specification and examples be considered as only, with a true scope of the disclosure being indicated by the following claims and their equivalents.

What is claimed is:

1. A communication controlling method, comprising:
obtaining a frequency-domain channel information by a first communication device;
transforming the frequency-domain channel information into a compressed data according to a sensing matrix by the first communication device;
transmitting the compressed data to a second communication device by the first communication device;
restoring the compressed data to a time-domain channel information by the second communication device; and
transforming the time-domain channel information into the frequency-domain channel information by the second communication device.

2. The communication controlling method according to claim 1, wherein the sensing matrix is a random linear combiner matrix.

3. The communication controlling method according to claim 1, wherein the second communication device stores the sensing matrix in advance.

4. The communication controlling method according to claim 1, further comprising:
notifying the first communication device to adjust the sensing matrix according to the time-domain channel information by the second communication device.

5. The communication controlling method according to claim 4, wherein a plurality of candidate matrices are stored in the first communication device in advance, and the sensing matrix is one selected from the plurality of candidate matrices.

6. The communication controlling method according to claim 1, wherein the time-domain channel information is transformed into the frequency-domain channel information by a fast Fourier transform (FFT) algorithm.

7. The communication controlling method according to claim 1, wherein the first communication device is a base station, and the second communication device is a server.

8. The communication controlling method according to claim 1, wherein the frequency-domain channel information is obtained by measuring a channel between the first communication device and a third communication device.

9. The communication controlling method according to claim 8, wherein the first communication device is a base station, and the third communication device is a user equipment.

10. The communication controlling method according to claim 1, wherein the step of obtaining the frequency-domain channel information by the first communication device further comprises:
receiving a reference signal by the first communication device, the reference signal being transmitted via an uplink channel; and
estimating the frequency-domain channel information according to the reference signal by the first communication device, wherein the frequency-domain channel information is a channel information of a downlink channel.

11. The communication controlling method according to claim 1, further comprising:
obtaining a compression ratio; and
providing the sensing matrix according to the compression ratio.

12. The communication controlling method according to claim 11, wherein the step of obtaining the compression ratio comprises:
calculating a sparsity according to the time-domain channel information; and
obtaining the compression ratio according to the sparsity and a mapping table.

13. A communication controlling system, comprising:
a first communication device, configured to obtain a frequency-domain channel information, transform the frequency-domain channel information into a compressed data according to a sensing matrix, and transmit the compressed data; and
a second communication device, configured to receive the compressed data, restore the compressed data to a time-domain channel information, and transform the time-domain channel information into the frequency-domain channel information.

14. The communication controlling system according to claim 13, wherein the sensing matrix is a random linear combiner matrix.

15. The communication controlling system according to claim 13, wherein the second communication device stores the sensing matrix in advance.

16. The communication controlling system according to claim 13, wherein the second communication device further notifies the first communication device to adjust the sensing matrix according to the time-domain channel information.

17. The communication controlling system according to claim 16, wherein a plurality of candidate matrices are stored in the first communication device in advance, and the sensing matrix is one selected from the plurality of candidate matrices.

18. The communication controlling system according to claim 13, wherein the time-domain channel information is transformed into the frequency-domain channel information by a fast Fourier transform (FFT) algorithm.

19. The communication controlling system according to claim 13, wherein the first communication device is a base station, and the second communication device is a server.

20. The communication controlling system according to claim 13, wherein the frequency-domain channel information is obtained by measuring a channel between the first communication device and a third communication device.

21. The communication controlling system according to claim 20, wherein the first communication device is a base station, and the third communication device is a user equipment.

22. The communication controlling system according to claim 13, wherein the first communication device is configured to receive a reference signal, the reference signal is transmitted via an uplink channel, the first communication device further estimates the frequency-domain channel information according to the reference signal, and the frequency-domain channel information is a channel information of a downlink channel.

23. The communication controlling system according to claim 13, wherein the first communication device further obtains a compression ratio, and provides the sensing matrix according to the compression ratio.

24. The communication controlling system according to claim 13, wherein the second communication device further calculates a sparsity according to the time-domain channel information, and obtains compression ratio according to the sparsity and a mapping table.

25. A base station, comprising:
a reference signal receiving unit, configured to receive a reference signal to obtain a frequency-domain channel information; and
a compressing unit, transforming the frequency-domain channel information into a compressed data according to a sensing matrix, the compressed data being transmitted to a server.

26. The base station according to claim 25, wherein the sensing matrix is a random linear combiner matrix.

27. The base station according to claim 25, further comprising:
a storage unit, configured to store the sensing matrix in advance.

28. The base station according to claim 25, wherein the compressing unit adjusts the sensing matrix according to an adjustment notification of the server.

29. The base station according to claim 28, further comprising:
a storage unit, configured to store a plurality of candidate matrices in advance,
wherein the compressing unit selects the sensing matrix from the candidate matrices.

30. The base station according to claim 25, wherein the frequency-domain channel information is obtained by measuring a channel between the base stations and a user equipment.

31. The base station according to claim 25, wherein the reference signal receiving unit comprises:
a receiver, configured to receive a reference signal, the reference signal being transmitted via an uplink channel; and
an estimator, configured to estimate the frequency-domain channel information according to the reference signal, the frequency-domain channel information being a channel information of a downlink channel.

32. The base station according to claim 25, wherein the compressing unit comprises:
a compression ratio adapter, configured to obtain a compression ratio; and
a sensing matrix obtainer, configured to provide the sensing matrix according to the compression ratio.

33. A server, comprising:
a compressed data receiving unit, configured to obtain a compressed data from a base station;
a restoring unit, configured to restore the compressed data to a time-domain channel information; and
a transforming unit, configured to transform the time-domain channel information into a frequency-domain channel information.

34. The server according to claim 33, wherein the restoring unit restores the compressed data to the time-domain channel information according to a sensing matrix and a fast Fourier transform (FFT) matrix, and the sensing matrix is a random linear combiner matrix.

35. The server according to claim 33, further comprising:
a storing unit, configured to store sensing matrix in advance.

36. The server according to claim 35, further comprising:
an adjusting unit, configured to notify the base station to adjust the sensing matrix according to the time-domain channel information.

37. The server according to claim 36, wherein the adjusting unit comprises:
a sparsity calculator, configured to calculate a sparsity according to the time-domain channel information; and
a compression ratio determiner, configured to obtain the compression ratio according to the sparsity and a mapping table, the sensing matrix being provided according to compression ratio.

38. The server according to claim 35, wherein the storing unit is configured to store a plurality of candidate matrices in advance, and the sensing matrix is one selected from the plurality of candidate matrices.

39. The server according to claim 33, wherein the transforming unit transforms the time-domain channel information into the frequency-domain channel information by a fast Fourier transform (FFT) algorithm.
